(19) United States
(12) Patent Application Publication
(10) Pub. No.: US 2013/0166350 A1
(43) Pub. Date: Jun. 27, 2013

(54) CLUSTER BASED PROCESSING FOR FORECASTING INTERMITTENT DEMAND

(71) Applicants: Thomas Reed Willemain, Niskayuna, NY (US); Nelson Seth Hartunian, Belmont, MA (US)

(72) Inventors: Thomas Reed Willemain, Niskayuna, NY (US); Nelson Seth Hartunian, Belmont, MA (US)

(73) Assignee: Smart Software, Inc., Belmont, MA (US)

(21) Appl. No.: 13/528,941

(22) Filed: Jun. 21, 2012

Related U.S. Application Data
(60) Provisional application No. 61/501,839, filed on Jun. 28, 2011.

(51) Int. Cl. G06Q 30/02

(52) U.S. Cl. CPC G06Q 30/0202
USPC 705/7.31

(57) ABSTRACT

A system, method and program product for cluster-based forecasting of intermittent demand. A computer system is disclosed for forecasting intermittent demand, having a data management system that provides access to historical demand data for a plurality of items; and a forecast system that generates a distribution of lead time demand predictions for a selected item having intermittent demand, and wherein the forecast system includes program code for performing the steps of: identifying a cluster from historical demand data, wherein the cluster includes items having an aggregated demand that defines a cluster driver; detecting if an association exists between historical demand data of a selected item and the cluster driver; and if the association is detected, utilizing the historical demand data of the selected item and the historical demand data to generate a distribution of lead time demand predictions.

### PRIORITY CLAIM

The present invention claims priority to co-pending provisional patent application Ser. No. 61/501,839, entitled Cluster-Based Forecasting for Intermittent Demand, filed on Jun. 28, 2011, the content of which is hereby incorporated by reference.

### BACKGROUND

1. Technical Field

The present invention relates to forecasting and inventory control, and more particularly, relates to forecasting intermittent demand using cluster based processing.

2. Related Art

In many of today's competitive commercial activities, such as manufacturing and retail, inventory management is increasingly recognized as one of the most important operational concerns. In particular, by maintaining precise inventory levels, a business entity can eliminate the need to manufacture, purchase, and/or store goods that are not immediately required. In order to achieve such goals, an inventory management system must have the ability to accurately forecast demand in order to predict inventory requirements.

One particular type of demand forecasting that is especially difficult to predict involves that of “intermittent demand,” which is characterized by frequent zero values intermixed with random nonzero values. Intermittent demand patterns are found in various situations, such as those dealing with spare parts or the sale of “big ticket” items. A typical intermittent demand data set will generally represent a sequence of requirements for a particular part over a period of time. For example, a parts supplier will typically track a monthly demand for each of their parts. Over a particular time span, for example 18-36 months, it may be apparent that demand for each part exists only during a few of the months. Thus, the demand history, on a month-by-month basis, might reflect that most of the monthly demand values were zero, while a small minority was nonzero. Because most intermittent demand sequences are assumed to have no trend or seasonality, and because the nonzero values can greatly vary, forecasting future demand based on such historical data has in the past involved nothing more than oversimplified and relatively inaccurate statistical methods. In turn, this makes it difficult to provide an effective inventory management system.

In general, demand forecasting involves using historical data to predict future requirements over some replenishment “lead time” L, for example, four months. The predicted requirements over the lead time are generally provided as a distribution of predictions and referred to as the lead time demand (LTD) distribution. Existing techniques used to forecast intermittent demand include single exponential smoothing and Croston's method. Single exponential smoothing forecasts usually assume the distribution of lead time demand to be described by a normal (i.e., Gaussian or “bell-shaped”) curve and use a smoothing process to estimate the mean and variance of the distribution. In practice, the total demand is usually regarded as normal, being the sum of L random variables that are independent and identically distributed. Of course, the normality assumption is unlikely to be strictly true, especially for short lead times that do not permit central limit theorem effects to shape the sum, as is the independence assumption.

### SUMMARY OF THE INVENTION

The present invention provides systems and methods for forecasting intermittent demand over a lead time using cluster based processing. In a first aspect, a computer system is disclosed having a processor and memory for forecasting intermittent demand, comprising: a data management system, wherein the data management system provides access to historical demand data for a plurality of items; a forecast system, wherein the forecast system generates a distribution of lead time demand predictions for a selected item having intermittent demand, and wherein the forecast system includes program code for performing the steps of: identifying a cluster from historical demand data, wherein the cluster includes a set of items having an aggregated demand that defines a cluster driver; detecting if an association exists between historical demand data of a selected item and the cluster driver; and if the association is detected, utilizing the historical demand data of the selected item and the historical demand data of the cluster to generate a distribution of lead time demand predictions for the selected item.

In a second aspect, a method if disclosed for forecasting intermittent demand, comprising: identifying a cluster from historical demand data, wherein the cluster includes a set of items having an aggregated demand that defines a cluster driver; using a computing device to detect if an association exists between historical demand data of a selected item and the cluster driver; and if the association is detected, utilizing the historical demand data of the selected item and the historical demand data of the cluster to generate a distribution of lead time demand predictions for the selected item.

In a third aspect, a computer readable storage medium is disclosed having a program product stored thereon for forecasting intermittent demand, comprising: program code that identifies a cluster from historical demand data, wherein the cluster includes a set of items having an aggregated demand that defines a cluster driver; program code that detects if an association exists between historical demand data of a selected item and the cluster driver; and program code that utilizes historical demand data of the selected item and historical demand data of the cluster to generate a distribution of lead time demand predictions for the selected item if the association is detected.

In a fourth aspect, the invention provides a cluster-based forecasting system for forecasting lead time demand for an item based on inputted intermittent data, wherein the forecasting system includes a processor and memory, and further comprises: a system that identifies a cluster from historical demand data, wherein a behavior of the cluster is characterized by a cluster driver; a forecast system that utilizes the cluster driver to forecast a demand value for a selected item in the cluster; a system that generates a lead time demand prediction for the selected item from a sequence of forecasted demand values; and a system that generates a distribution of lead time demand predictions for the selected item.

In a fifth aspect, the invention provides a cluster-based forecasting method for forecasting lead time demand for an item based on inputted intermittent data, wherein the method comprises: using a computing system to identify a cluster from historical demand data, wherein a behavior of the cluster is characterized by a cluster driver; utilizing the cluster driver to forecast a demand value for a selected item in the cluster; generating a lead time demand prediction for the selected item from a sequence of forecasted demand values; and generating a distribution of lead time demand predictions for the selected item.

In a sixth aspect, the invention provides a computer readable storage medium having a program product stored thereon, which when executed by a computer system, comprises: program code that identifies a cluster from historical demand data, wherein a behavior of the cluster is characterized by a cluster driver; program code that utilizes the cluster driver to forecast a demand value for a selected item in the cluster; program code that generates a lead time demand prediction for the selected item from a sequence of forecasted demand values; and program code that generates a distribution of lead time demand predictions for the selected item.

The foregoing features and advantages of the invention will be more apparent in the following and more particular description of the preferred embodiments of the invention as illustrated in the accompanying drawings.

### BRIEF DESCRIPTION OF DRAWINGS

The preferred exemplary embodiment of the present invention will hereinafter be described in conjunction with the appended drawings, where like designations denote like elements, and:

FIG. 1 depicts a high level system overview of a computer system containing a forecasting program in accordance with an embodiment of the present invention;

FIG. 2 depicts a flow diagram of process flow in accordance with an embodiment of the present invention;

FIG. 3 depicts a high level flow diagram of a method of forecasting in accordance with an embodiment of the present invention;

FIG. 4 depicts a flow diagram for selecting next demand values in accordance with an embodiment of the present invention;

FIG. 5 depicts a plot showing total demand for a set of items;

FIGS. 6-8 depict plots showing historical demand association between a selected item and set of items;

FIG. 9 depicts a flow chart for implementing a weighting kernel methodology in accordance with an embodiment of the present invention;

FIG. 10 depicts a set of plots illustrating an implementation of the weighting kernel methodology in accordance with an embodiment of the present invention;

FIG. 11 depicts illustrative graphs and tables showing an implementation of a Binary Bayes process in accordance with an embodiment of the present invention.

FIG. 12 depicts a flow chart showing an implementation of a Binary Bayes process in accordance with an embodiment of the present invention.

FIG. 13 depicts an overview of the Linked Markov Model process in accordance with an embodiment of the present invention.

FIG. 14 depicts an example of item demand and cluster drivers.

FIG. 15 depicts a heat plot of item demand for a set of five clusters.

FIG. 16 depicts a flow chart of a cluster based forecasting system in accordance with an embodiment of the invention.

### DETAILED DESCRIPTION OF THE INVENTION

### I. Overview

In any inventory management problem, one of the critical goals is to balance the need to have stock on hand to satisfy random demand against the cost of maintaining that stock. Efficient management of this tradeoff requires accurate forecasts of the distribution of the total demand that will arise over a lead time needed for stock replenishment. Unfortunately, the intermittent nature of demand for spare parts or high priced capital goods makes forecasting especially difficult. Since demand alternates sporadically between zero and nonzero values, traditional forecasting methods are typically rendered ineffective.

As previously noted, intermittent demand is generally defined as random demand with a large proportion of zero values. In addition, demand that is intermittent is also often “lumpy,” meaning that there is a great variability among the nonzero values. Examples with these characteristics include demand for spare parts and high priced capital goods such as heavy machinery, jet engine tools and aircraft. For the purposes of this disclosure, the term “demand” may include any type of data capable of being captured in some sequential fashion. Accordingly, the invention is not intended to be strictly limited to forecasting inventory.

However, in one embodiment, the forecasting techniques described herein could be implemented with an inventory management system. For instance, the techniques could be integrated into an inventory management system that utilizes the theory of economic order quantities under a continuous review model. The continuous review model determines two quantities for each item, a reorder point and an order quantity. When on-hand inventory reaches the reorder point, one orders an amount equal to the order quantity to replenish stock. Calculating the reorder point requires forecasts of the entire distribution of demand over the lead time, defined as the time between the generation of a replenishment order and its arrival in inventory. Calculating the order quantity normally requires forecasts only of the average demand per period.

In another embodiment, the inventory management system can use a periodic review model, which determines a review interval and an “order-up-to level.” Under this model, the status of the on-hand inventory is checked only at fixed intervals called “review periods,” e.g., every 3 months. There will almost always be some reduction in on-hand inventory during a review period. When this occurs, the user would place a replenishment order large enough to return the total inventory (on-hand plus on-order) to a specified order-up-to level.

In addition to providing the above re-order information for continuous and periodic review models, the forecasting techniques could be integrated with a system that also provides performance measures. Performance measures depend not only on the demand forecasts, but also on economic, operational and service level factors or values supplied. The economic factors include costs for holding and ordering inventory. The operational factors specify what happens when demand exceeds on-hand inventory, i.e., lost orders or back orders. The service level factors include a choice of service level criterion and the minimum acceptable value for that criterion. For example, it may be desirable to find the least-cost parameters that will ensure that 95% of all units demanded can be supplied immediately out of on-hand inventory.

The approach taken for forecasting intermittent demand in accordance with this invention employs sample reuse methods. Sample reuse can be defined as a method of creating simulated predictions based on sampled historical data. Sample reuse first creates a sequence of predicted future demand values, wherein each value represents a prediction for a future time period. Summing a sequence of values provides a lead time demand (LTD) prediction. Next a collection of LTD predictions are generated to form a distribution that can thereafter be statistically analyzed or, e.g., be inputted into an inventory control system. The advantage of utilizing sample reuse methodologies for forecasting intermittent data is that it not only reproduces standard results in standard situations, but it also applies to situations that lack analytical formulas or that violate the assumptions on which available formulas are based.

Sample reuse thus generates an LTD forecast made up of a distribution of LTD predictions, wherein each LTD prediction is obtained from a sequence of predicted demand values. For example, assume a collection of historical demand data exists for an item for months 1-12 as shown below in Table 1.

TABLE 1

| | MONTH | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| DEMAND | 0 | 0 | 0 | 4 | 0 | 0 | 1 | 0 | 1 | 0 | 2 | 0 | ? | ? | ? | ? |

The goal is to forecast the lead time demand (LTD) over a predetermined lead time, e.g., months 13-16. Sample reuse creates a distribution of N possible LTD predictions for that 4 month lead time. To achieve this, a sequence of values for months 13-16 are generated and summed to provide a single LTD prediction. This is then repeated or replicated N times, thus requiring N sequences, each having a cumulative LTD sum indicated in Table 2 as LTD(N). Table 2 provides an LTD distribution with five predictions, i.e., N=5.

TABLE 2

| N | Sequence | LTD(N) |
|---|---|---|
| 1 | 0012 | 3 |
| 2 | 0000 | 0 |
| 3 | 0100 | 1 |
| 4 | 2404 | 10 |
| 5 | 0020 | 2 |

In a typical real world application, the number of replicates N would be a much higher number, for example N=50,000. A distribution of the N LTD predictions can then be analyzed to generate statistical information and/or be fed into an inventory control program for forecasting purposes. This disclosure provides a number of cluster based techniques for generating the required sequences of predicted values.

Known techniques for generating a sequence of lead time values include bootstrapping, which randomly samples values from the historical data. In U.S. Pat. No. 6,205,431, System and Method for Forecasting Intermittent Demand, issued to Willemain et al. on Mar. 20, 2001, which is hereby incorporated by reference, the Smart Bootstrap was disclosed which (1) incorporated a Markov modeling process to better predict if the next value in an LTD sequence was going to be zero or nonzero; and (2) incorporated a jittering technique in which selected historical values were randomly changed to “neighboring” values in order to enlarge the set of possible forecast values used in the sequence.

The present approach likewise utilizes “sample reuse” forecasting to simulate the distribution of demand over a fixed lead time for an item. However, the current approach utilizes cluster based processing, where appropriate, to evaluate historical data for a “second variable” associated with a selected item to improve the forecast of the selected item. For instance, in an inventory control process that tracks parts for a complex machine, there may be hundreds or thousands of parts that make up the machine. Historical demand for a selected part may be associated with demand patterns for one or more clusters (or “families”) of related parts. Once such a cluster is identified, historical demand data of the entire cluster may be used to improve accuracy when forecasting demand of the individual selected part.

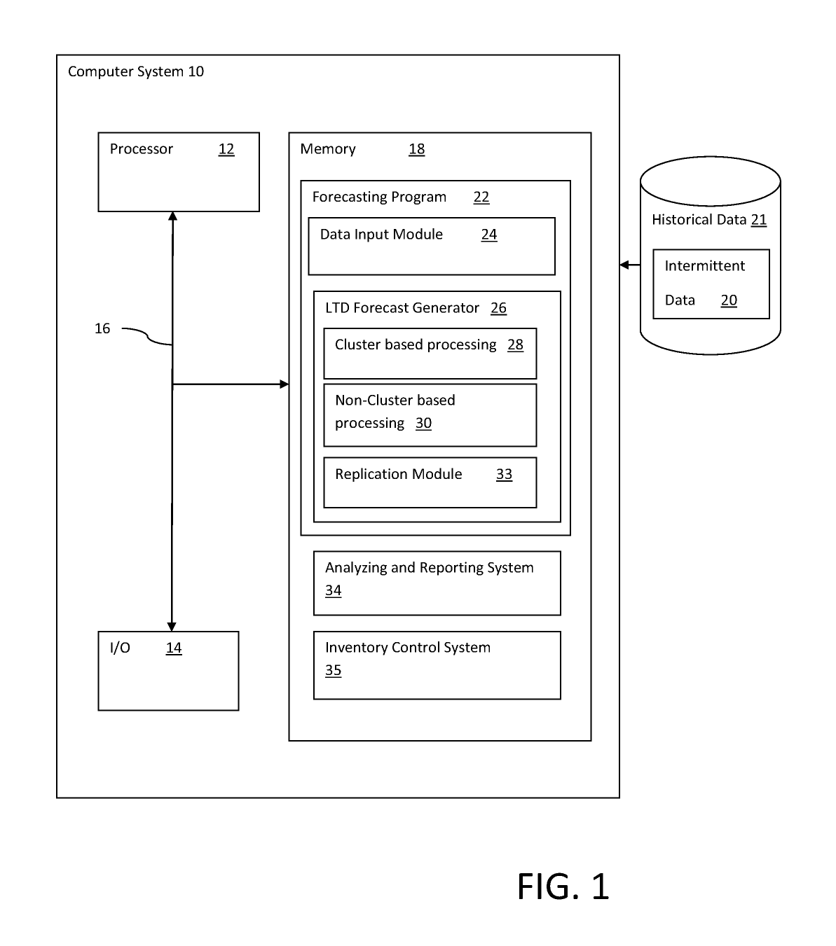

Referring now to FIG. 1, a computer system 10 is shown depicting a forecasting program 22 residing in memory 18. The computer system 10 comprises a processor 12, and input/output (I/O) 14, and a bus 16. As can be seen, memory 18 contains a forecasting program 22 comprising a data input module 24 and an LTD forecast generator 26. The data input module 24 is used to input historical data 21 that includes intermittent data 20. Historical data 20 generally comprises a collection of historical demand data over a period of time for a plurality of parts or items. LTD forecast generator 26 is used to generate LTD forecasts based on the historical data 21, which can then be fed into analyzing and reporting system 34 and/or inventory control system 35. Analyzing and reporting system 34 provides tabular and graphical displays based on generated LTD forecasts, and provides lead time demand calculations based upon a statistical analysis of the LTD forecasts.

The LTD forecast generator 26 generates LTD sequences utilizing cluster based processing 28 (described in further detail herein) and/or non-cluster based processing 30 (e.g., traditional bootstrap, Smart Bootstrap, etc.). Once an LTD sequence is generated, the values are summed to generate an LTD prediction. Replication module 33 is essentially a looping mechanism used to generate a distribution of N LTD predictions. The actual number of replications N can be user defined or defined by some other constraint. Once the N LTD predictions are collected, analyzing and reporting module 34 is used to provide statistical results that can be examined by the user, or fed into a subsequent process, such as an inventory control system 35. The particular techniques used by the forecasting program 22 are described in more detail below.

It is understood that forecasting program 22 can be implemented as any type of computer program product and reside in any computer readable device suitable for storing computer instructions, including magnetic media, optical media, random access memory, read only memory, etc.

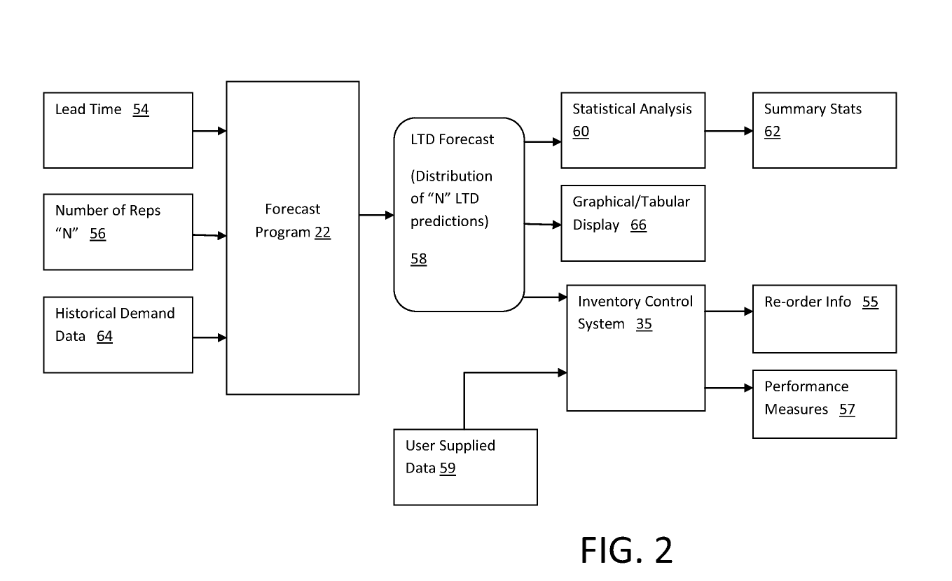

Referring now to FIG. 2, an illustrative overview of the flow of the forecasting program 22 is depicted. In this case, forecast program 22 comprises three inputs; a lead time 54, a number N for specifying the number of replications 56, and the historical intermittent demand data 64. The forecast program 22 outputs an LTD forecast in the form of a distribution 58 of N LTD predictions, which can be presented in a graphical or tabular display 66, or statistically analyzed 60 to provide summary statistics 62. The statistical analysis 60 may estimate, e.g., a mean, median, standard deviation, minimum, fixed percentile (e.g., 99th), and/or a maximum. Alternatively, a user could preselect demand levels of interest and then show the estimated probability of exceeding those levels.

It is understood that although this illustrative embodiment describes inputting a lead time 54 that is fixed, the lead time 54 may also encompass a random lead time. Specifically, the random lead time could comprise a distribution of possible lead times. In this case, each replicate (or sequence of LTD values) would be of varying size, depending upon a random selection from the inputted distribution of lead times.

Also shown in FIG. 2 is an inventory control system 35 that receives the distribution of lead time demand predictions 58 along with user supplied data 59. The user supplied data 59 may include holding, ordering, and shortage costs for inventory items. The data 59 may also include service level percentages that the user would like to meet. These may include percentage of units supplied from inventory, percentage chance of no stock out during lead time, and the size of replenishment shortfalls.

The output of the inventory control system generally comprises reorder information 55 and performance measures 57. The reorder information 55 may include an economic order quantity (EOQ) and reorder point for a continuous review model and a review interval and order up-to level for a periodic review model. The performance measures 57 provide percentages for the above mentioned service levels.

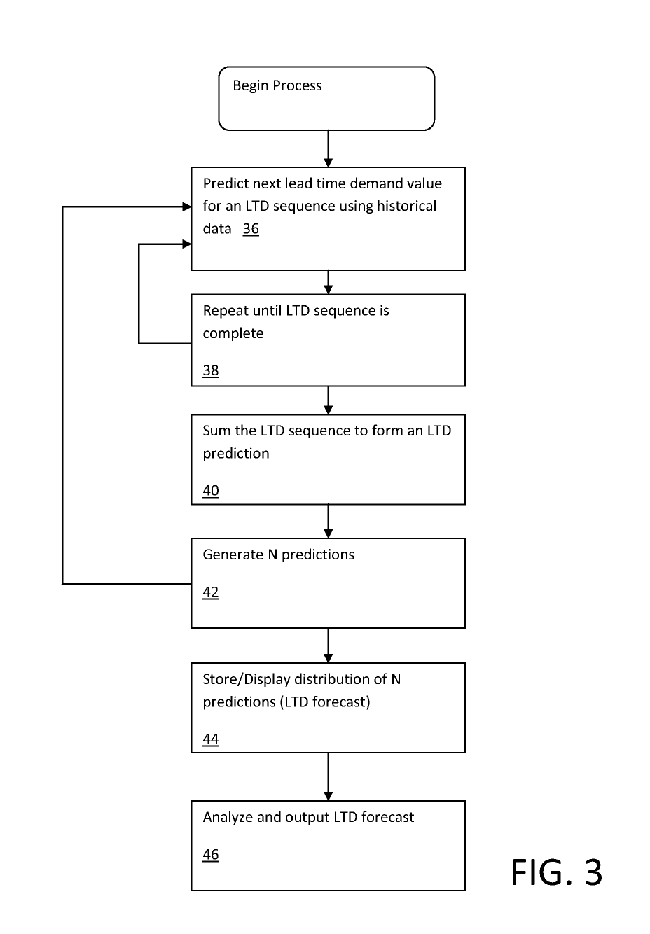

Referring now to FIG. 3, a flow chart for implementing an illustrative sample reuse methodology in accordance with this invention is depicted. As described above, a feature of the invention is to generate LTD sequences that can be summed into a distribution of LTD predictions. The first step 36 is to predict “a next LTD demand value” for the LTD sequence for a selected item based on the historical data. Historical data may include data associated with the selected item as well as data associated with related items. Techniques for predicting a next LTD demand value in a sequence are described in further detail below.

The prediction process 36 is repeated until an LTD sequence is complete 38. The size of the LTD sequence is equal to the number of months or other time/measurement periods that make up the lead time. For example, if a user wanted to know how many widgets would be required over the next four months, the LTD sequence size would equal four. Once the LTD sequence is complete, the lead time demand values making up this sequence are summed 40 to generate a first LTD prediction, e.g., LTD(1). Next 42, the entire process is replicated N times to create N LTD predictions, LTD(1), LTD(2) . . . LTD(N). Once the N LTD predictions are created, a histogram and/or other type of distribution representation can be stored and/or displayed 44. The distribution (i.e., LTD forecast) can then be analyzed 46 to generate summary statistics, or be used as input to an inventory control system 35.

### II. Predicting LTD Sequences Using Cluster Based Processing

In a typical product based inventory management system, the product (e.g., an airplane, a lawn mower, a turbine, etc.) or set of products may incorporate thousands of parts or items. Demand for some of the items may exhibit similar behaviors, e.g., demand for certain parts may go up in the winter and down in the summer, while other parts may simply behave independently. A shared behavior or pattern is embodied in an aggregated set of individual item demands characterized or defined as a “cluster driver”. Grouping items into clusters provides an advantage in that significantly more historical data can be exploited to predict future demand values, thereby increasing the accuracy.

Existing techniques for generating LTD sequences essentially utilize historical data only of the selected item being analyzed (i.e., a single variable). The current approach seeks to utilize historical data of both the selected item itself (a first variable) and other related items, i.e., clusters (a second variable). For the purposes of this disclosure, a cluster may include any set of items in which data associated with the items is somehow related, i.e., the items share the same driver. In some cases, a useful choice of driver is simply the sum of all individual item demands, implying there is one all-inclusive cluster. In other cases, clusters might be defined by whether their constituent items have positive or negative associations with the sum of all item demands.

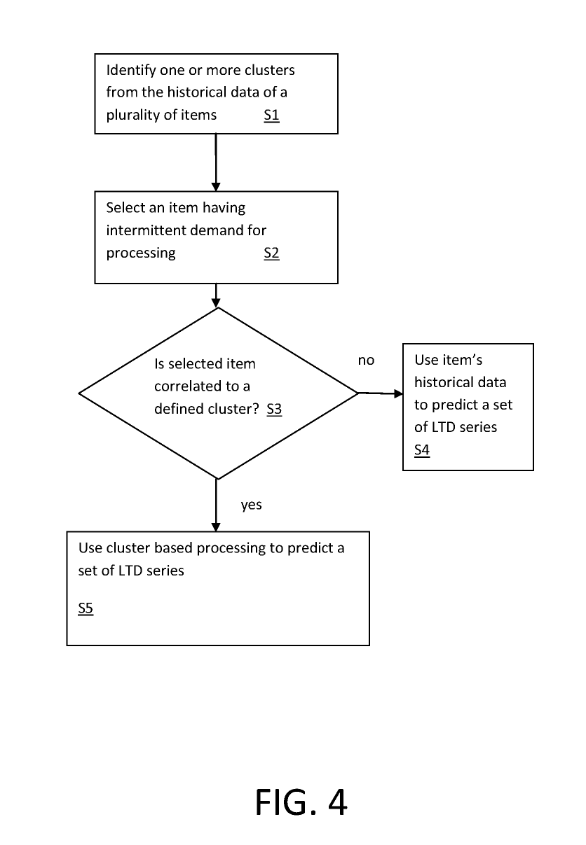

Association between a selected item and a cluster driver can be determined in any now known or later developed manner. Association may for example be established if the item behaves similarly or oppositely to a cluster. Accordingly, if a selected item can be associated with one or more cluster drivers, then data from the cluster(s) can be utilized to improve LTD sequence predictions. FIG. 4 depicts an overview of the cluster based processing. At S1, one or more clusters and associated drivers are identified from a historical set of data for a plurality of items. At S2, an item is selected for processing having intermittent demand. At S3, a determination is made whether the selected items can be associated with an identified cluster driver. If no, then a traditional process based on historical data of the selected item is used to predict the set of LTD sequence at S4. If yes, then cluster based processing is used to predict the set of LTD sequence at S5.

Various cluster based processing techniques are described herein. The first two, referred to as the Kernel Weighted Method and Binary Bayes Method, utilize the demand data of a total set of related items as the driver to define a cluster. The third, referred to as the Linked Markov Method, builds on the Smart Bootstrap approach by utilizing data from an identified cluster to modify the transition probabilities in a binary Markov Model. It is understood that any number of possible cluster-based processing techniques could be used within the context of this invention, and that the following approaches are intended only as illustrative embodiments and not intended to limit the overall scope of the invention.

### III. Clustering Based on Total Demand

In the case of the Kernel Weighted and Binary Bayes processes, identification of a cluster can be done with very little analysis, and in one embodiment, a cluster may simply comprise demand data for a total set of items. For example, if a product (or set of products) has 10,000 parts or items that make up the product (or set of products), then the cluster can include all of the items and the driver is the aggregate of the demand data for all of the items. This reduces complexity since there is no need to identify elusive drivers that define clusters within the entire data set.

It is understood, however, that when utilizing the Kernel Weighted or Binary Bayes processes, the set of items forming a cluster may be identified in any manner, e.g., the set may include a subset or superset of related items. For example, in an aircraft, the set of related items may be defined as all items that make up the engine; in a printer, the set of related items may be defined as all items found in a line of printers sold by a manufacturer; in an auto parts store, the set of related items may be defined as all products sold by the store. Accordingly, any set of related items may form a cluster.

Assuming the cluster is defined as the total set of items, the next step for both approaches is to determine if there is a historical demand association between a selected item and the total set of items. For the purposes of this disclosure, the term “association” may mean any relationship or correlation. In one illustrative embodiment, the process determines if there exists a positive association, a negative association, or no association. If there is a positive or negative association, then either the Kernel Weighted or Binary Bayes method can be applied. Otherwise, a non-cluster based approach may be utilized (e.g, bootstrapping, Smart Bootstrap, etc.).

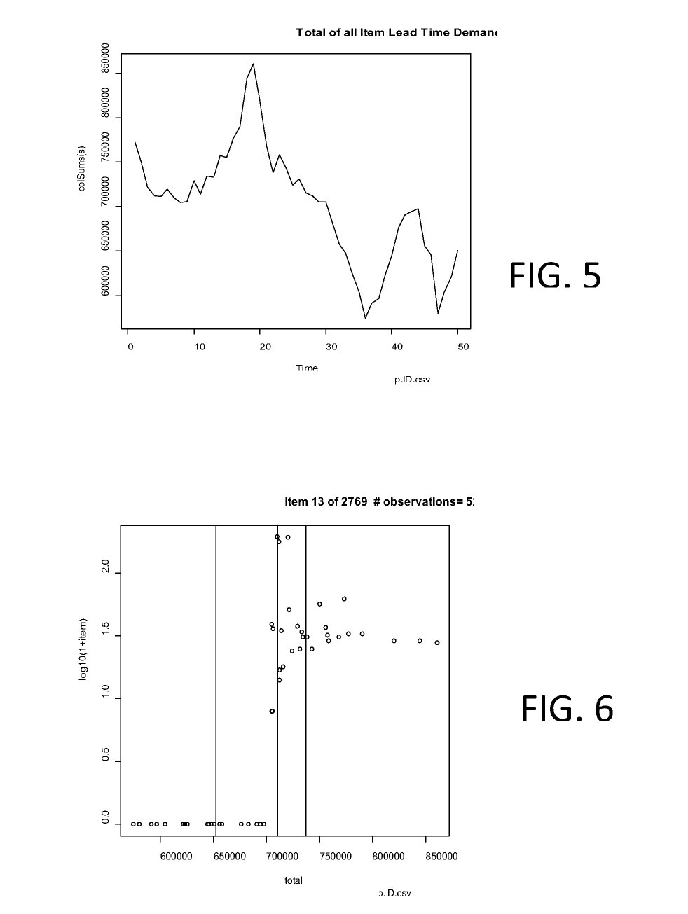

Determining if an association exists may be done in any manner. FIGS. 5-8 depict an illustrative approach for making this determination. Assume a set of related items has a total historical demand curve (i.e., driver) such as that shown in FIG. 5. As can be seen, over 50 time periods (e.g., months), the total demand for all items fluctuates between approximately 550,000 and 850,000.

FIGS. 6-8 depict demand association plots for selected items 13, 14 and 5, respectively. FIG. 6 shows a scatter plot of the historical demand of a selected item 13 relative to the total historical demand for all items. Each point on the plot depicts a unique time period (e.g., month). The x-axis measures total demand for all 2,769 items, while the y-axis measures demand for the selected item (item 13). As can be seen, when the total historical demand was low (e.g., below 700,000) the historical demand for the selected item was also low, i.e., almost always zero. Conversely, when the total demand for all items was higher, above 700,000, the demand for the selected item likewise increased and was never zero. This indicates a positive association between the selected item and the set of total items.

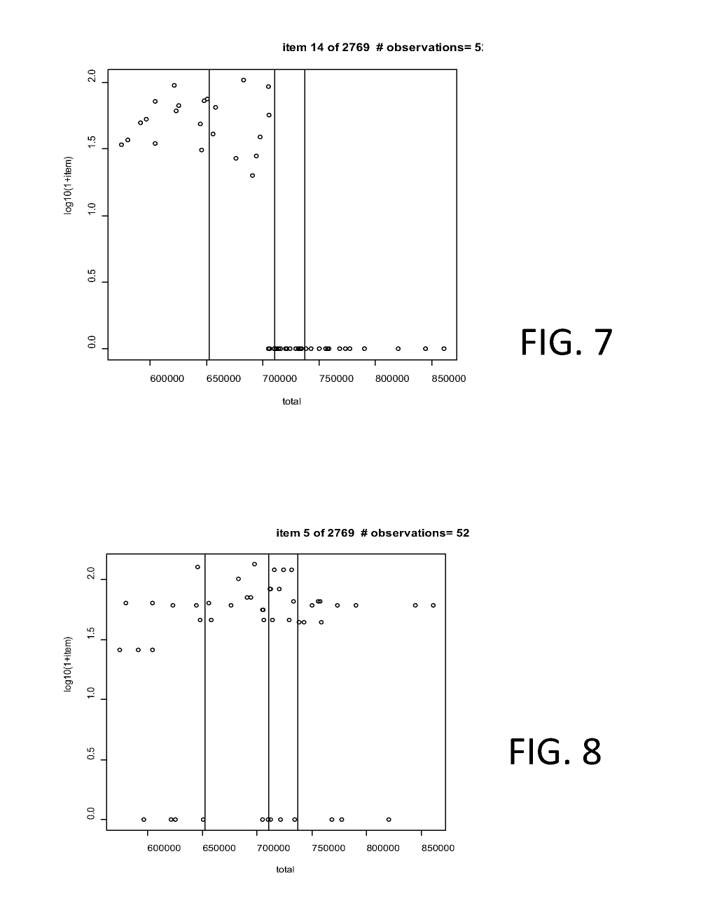

FIG. 7 shows a similar plot for a second selected item (item 14). In this case, when the total demand for all items was high (above 700,000), the demand for the selected item was always zero. When the total demand was low (below 700,000), the demand for the selected item was high (never zero). This indicates a negative association.

FIG. 8 shows an additional plot for a third selected item (item 5) in which there is no association between the total demand and the selected part. The historical demand for the selected part was not associated with the total demand, i.e., its distribution remained relatively constant regardless of the total demand.

a. Kernel Weighted Process

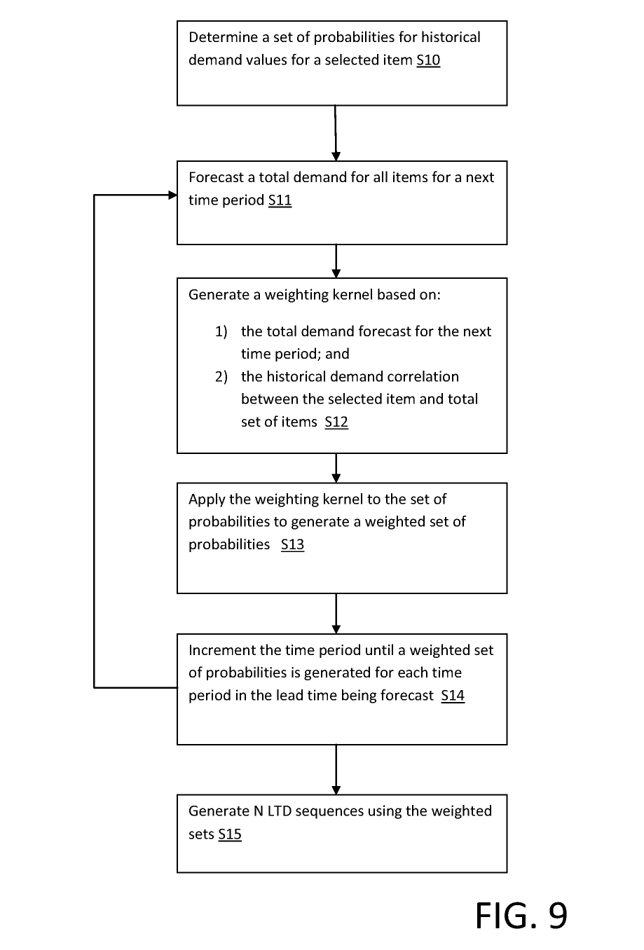

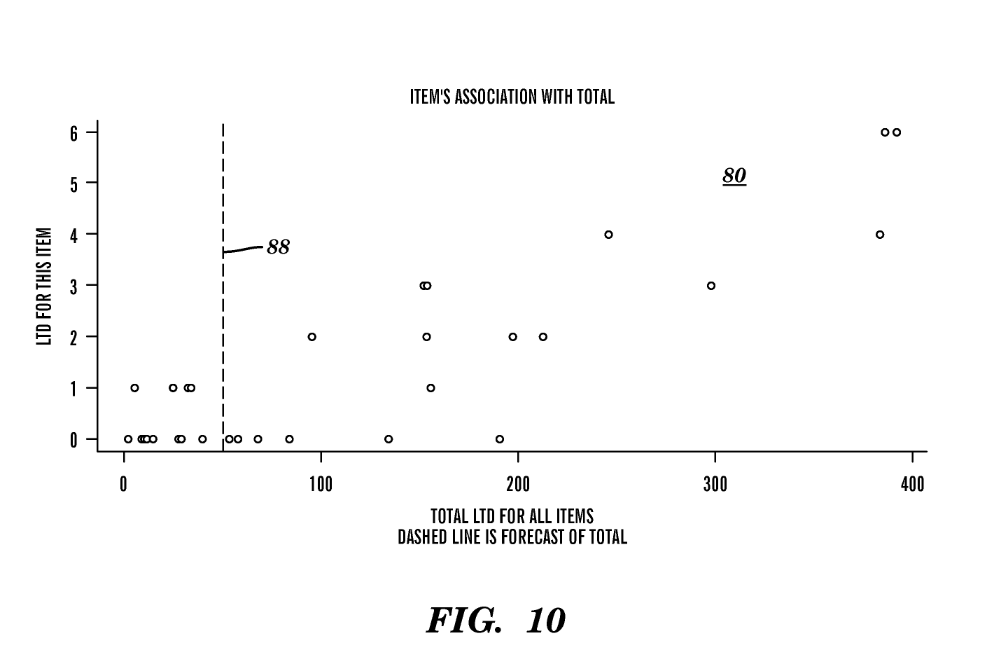

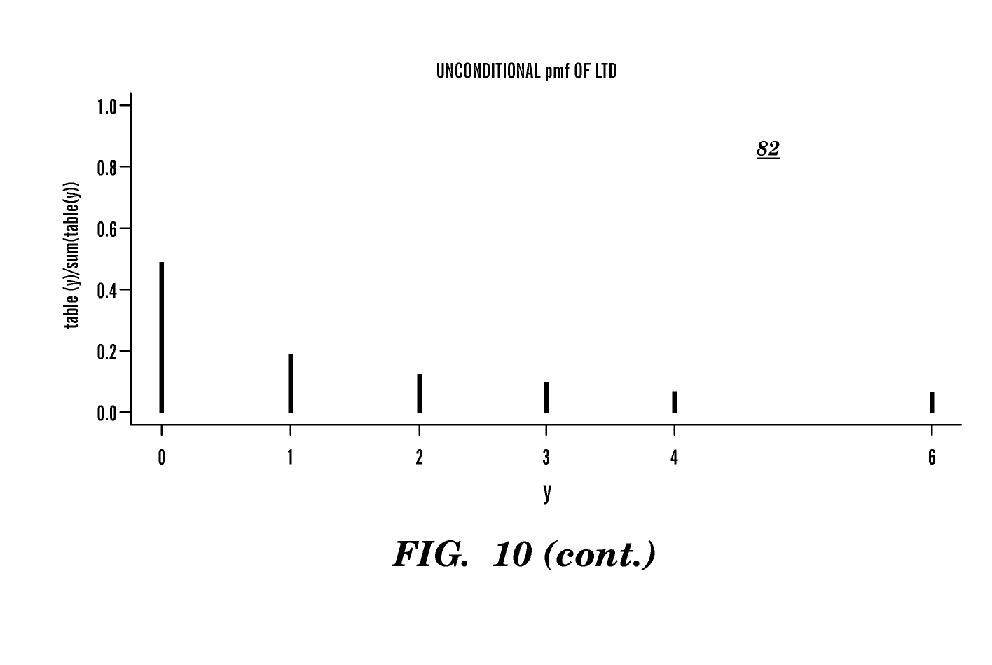

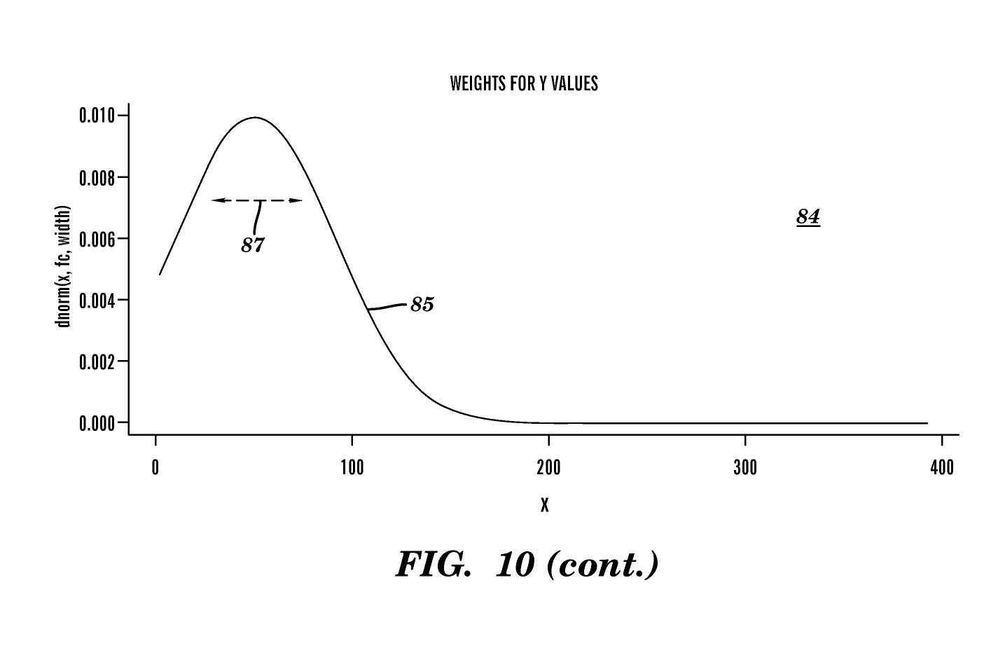

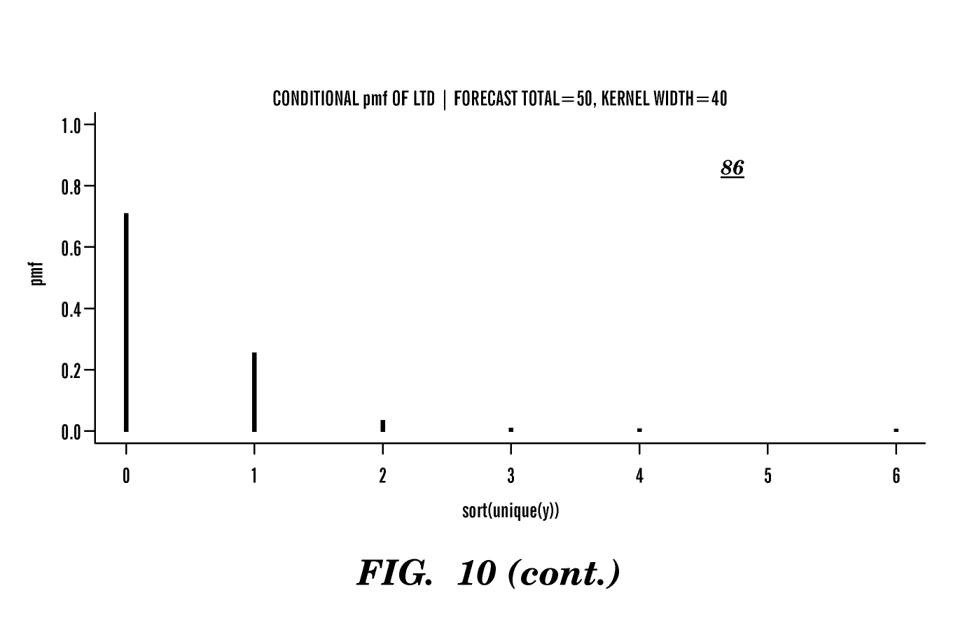

In general, the kernel weighted process generates a weighted set of probabilities for demand values for each future time period in a desired lead time. Each weighted set can then be used to predict a demand value for a future time period based on generated probabilities. An illustrative process is described with reference to FIGS. 9 and 10.

Plot 80 in FIG. 10 depicts the historical demand association between a selected item and total set of items. As can be seen, there is a positive association.

At S10 in FIG. 9, a set of “unconditional” probabilities are determined for a selected item based on historical demand values. An example of this is shown in plot 82 of FIG. 10, where demand values appear on the x-axis and probabilities appear on the y-axis. As can be seen, based on historical data, demand values for the selected item include 0, 1, 2, 3, 4, and 6, with demand value 0 having a 45% probability, 1 having a 20% probability, 2 having a 15% probability, and so forth.

Next at S11 (FIG. 9), the total demand for all items is forecast for a next time period. This forecast may be done in any known statistical manner (e.g., Winters' exponential smoothing). An illustrative forecast is shown in plot 80 as the vertical bar 88. In the case, the total demand forecast for the next time period is about 50. As can be seen, when the total demand was in the neighborhood of 50, historical demand for the selected item was typically low, e.g., likely a 0 or 1.

A feature of this approach is converting an unconditional probability distribution of item demand (plot 82) into a conditional distribution (plot 86) related to the forecast of total demand. The conditional distribution is computed by giving extra weight to historical demands in the “neighborhood” of the forecasted total, where the notion of neighborhood is operationalized in the choice of the width of the weighting kernel 85.

Accordingly, at S12, a weighting kernel is generated based on: (1) the total demand for the next period; (2) the observed association between the selected item and the total set of items; and (3) a determined width of the kernel. An illustrative weighting kernel 85 is shown as a curve in plot 84 of FIG. 10. In this case, the weighting kernel 85 has a width 87 indicated by the dotted line. The width 87 of weighting kernel 85 may be determined in any manner.

At S13, the weighting kernel is applied to the set of “unconditional” probabilities (e.g., plot 82) to generate a weighted set of “conditional” probabilities (e.g., plot 86). More particularly, the weighting kernel 85 is applied to plot 80 such that when counting the number of points at each demand level (e.g., 0's, 1's 2's, etc.), points near the forecast demand line 88 get weighted more and points further away get weighted less. An illustrative result is shown in plot 86 of FIG. 10. As can be seen, the probabilities have been weighted such that the conditional probability of 0 demand increased to about 70%, the probability of 1 increased to about 25%, the probability of 2 decreased to about 5%, and the probabilities of 3, 5 and 6 decreased to about 1%.

At S14, the forecasted time period is incremented and the process is repeated until a weighted set of “conditional” probabilities is generated for each time period in the lead time being forecast. (Thus, for the example shown in Table 1 above, four different weighted sets of “conditional” probability values would be generated corresponding to lead time months 13, 14, 15, 16.)

Once all of the weighted sets are generated, a distribution of N LTD sequences can be generated using the weighted probabilities. This can be done in any known manner, e.g., Monte Carlo method, etc. For example, assume the lead time consisted of four months, 13, 14, 15, 16. The first weighted set would be utilized to predict demand levels for month 13 (i.e., based on associated probabilities), the second weighted set would be utilized to predict demand levels for month 14, the third weighted set would be utilized to predict demand levels for month 15, and the fourth weighted set would be utilized to predict demand levels for month 16. The resulting N LTD sequences can then each be summed to provide a distribution of N LTD predictions that exploits the observed association.

Accordingly, a goal of kernel weighting is to convert the unconditional distribution of demand values into a conditional distribution that leverages the forecast of the driver, i.e., the total demand. This focuses the forecasting process on the relevant portion of the selected item's demand history, which is the demand that occurred when past conditions were most like what they are forecasted to be.

Focusing is implemented by downweighting historical demand data that are not in the “neighborhood” of the forecast value 88 in FIG. 10. The width 87 (also referred to as “bandwidth”) of the kernel function 85 determines the size of the neighborhood.

In one embodiment, the kernel width is determined by selecting a fixed number of “nearest neighbors” to the forecast line 88. In another illustrative embodiment, the number of neighbors may be set as a percentage (e.g., 30%) of the total number of data points in the scatter plot. This procedure results in an adaptive choice of kernel width. That is, in regions of the scatter plot that contain many data points, such as the left side of plot 80, the width shrinks, while the width expands in regions with few data points, such as the right side of 80.

b. Binary Bayes Process

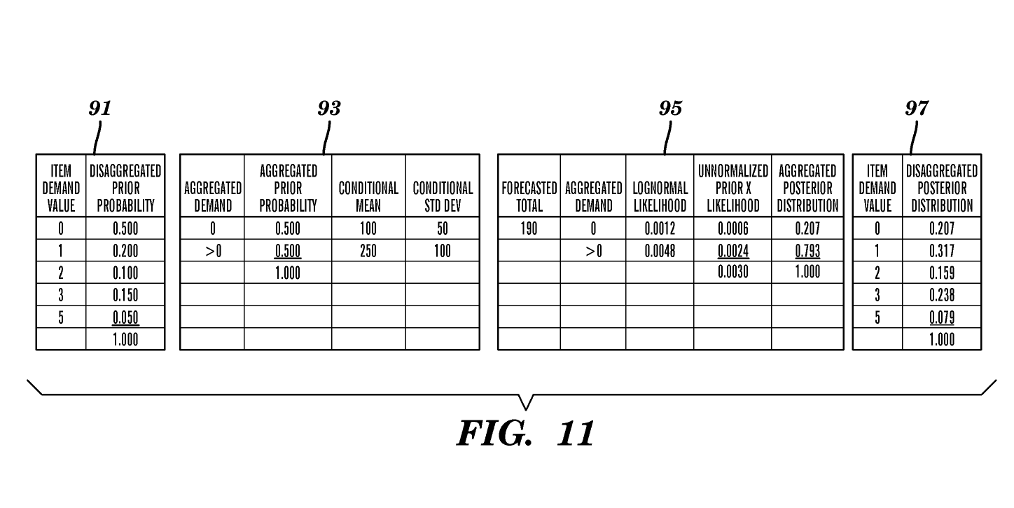

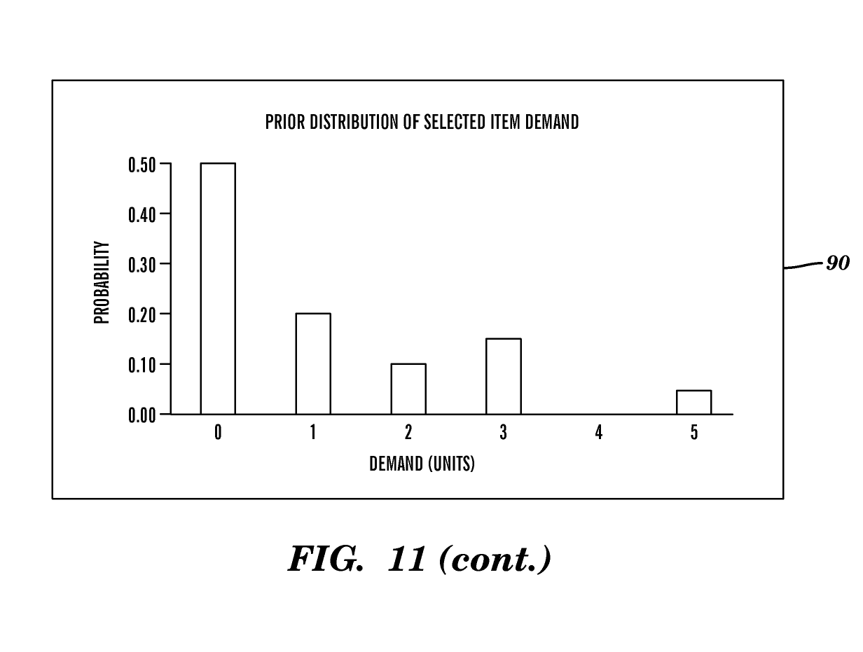

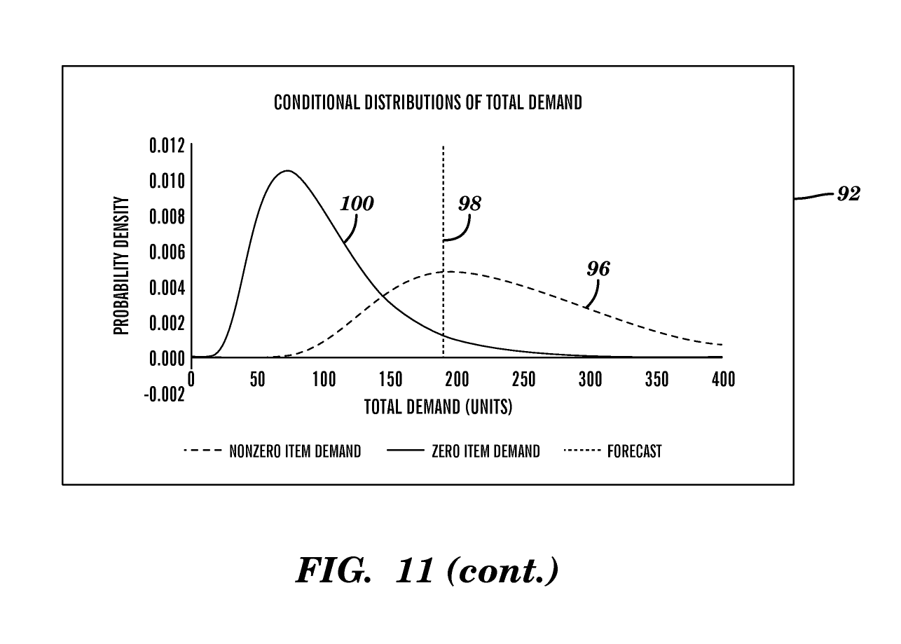

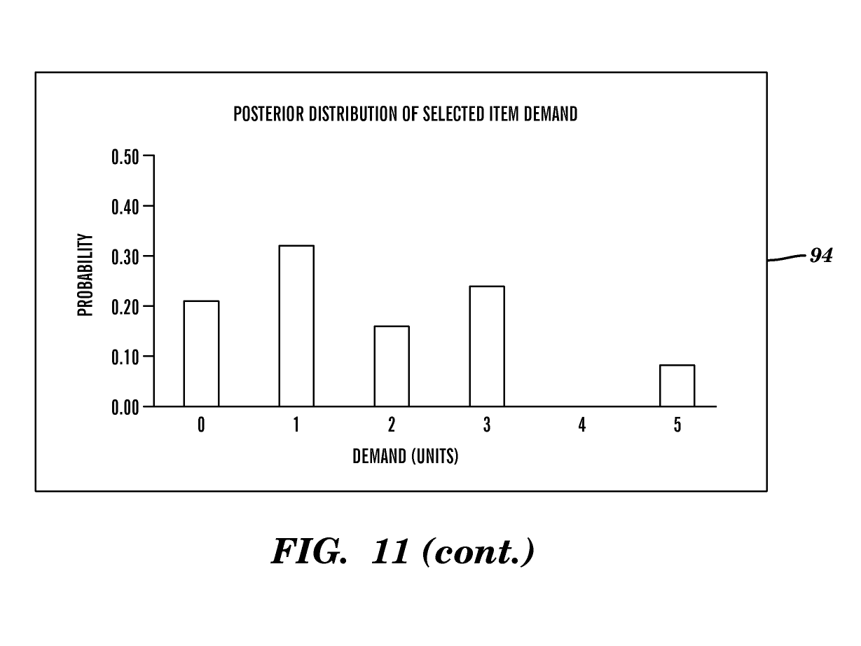

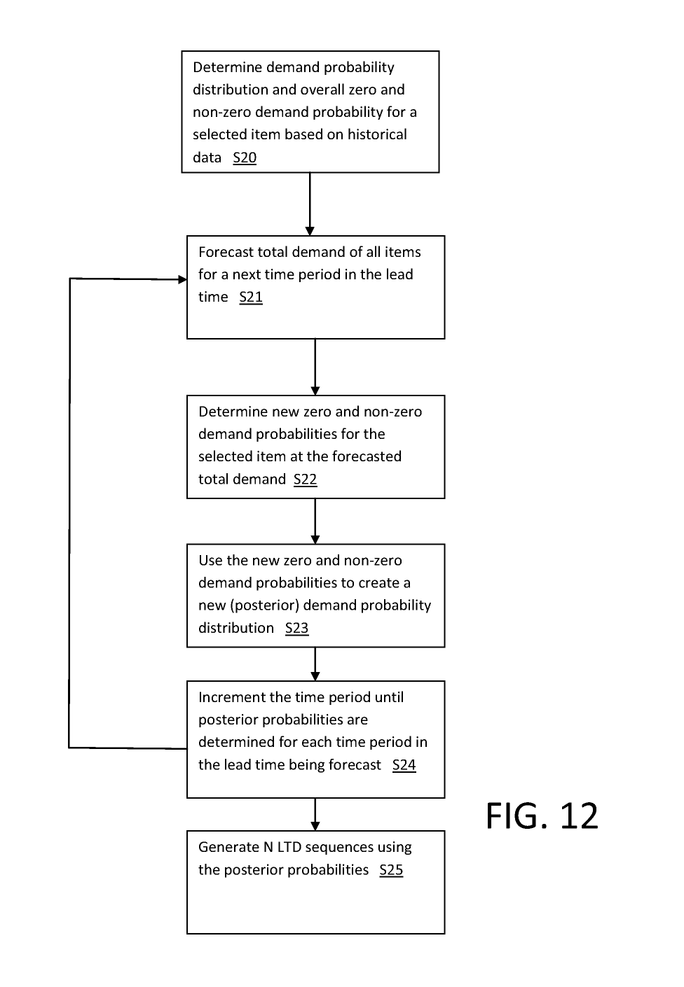

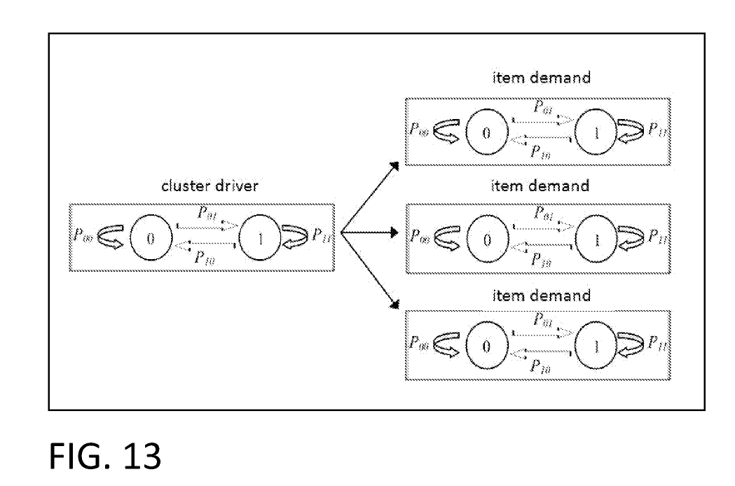

The Binary Bayes process seeks to determine a probability that a predicted value in an LTD sequence will either be a zero or nonzero value. Based on those probabilities, each predicted value is determined to be one of either zero or nonzero using, e.g., some random selection technique. If the predicted value is nonzero, then the nonzero is assigned an actual nonzero value based, e.g., on historical demand values and their associated probabilities. An illustrative process is described with reference to FIGS. 11 and 12.

As with the Kernel Weighted process, the first step is to determine if there exists an association between a selected item and the total set of items. There are several ways to test for this association. One way this can be done is as follows:
1. Show a scatterplot of total demand (y-axis) versus item demand (x-axis).
2. Assemble the data into two groups according to whether the item demand is zero or nonzero.
3. Perform a Wilcoxon nonparametric test of equality of distributions of the total demand for the two groups.
4. If the test is significant, apply a Binary Bayes Process; if not, use a non-cluster based process.

### Alternatively:

1. Show a scatterplot of total demand (y-axis) versus item demand (x-axis).
2. Calculate either the product-moment or rank-order correlation between the individual and total demand values.
3. Perform a permutation test on the observed correlation. That is, randomly permute the order of the values of demand for the individual item, calculate the resulting sample correlation, and repeat sufficient times to estimate the sampling distribution of the sample correlation when there is, by construction, no association.
4. If the observed sample correlation is statistically significant, apply the Binary Bayes Process; if not, use a non-cluster based process.

FIG. 11 shows an example of the Binary Bayes Process described using four data blocks 91, 93, 95 and 97 and three graphs 90, 92 and 94. The first (leftmost) block 91 shows the historical demand distribution for a selected item. Past demand values of 0, 1, 2, 3 and 5 were observed in various proportions, with 50% of the values being zero. This is also shown graphically in graph 90.

In the second block 93, total demand is aggregated into two groups according to whether individual demand was zero or nonzero. Among all the occasions when item demand was zero units, the total demand for all items (i.e., the driver values) averaged 100 units with a standard deviation of 50 units. In contrast, when item demand was nonzero, the total demand was both higher and more variable, averaging 250 units with a standard deviation of 100. These differences reflect the association between the total and the selected item. Both of the conditional distributions of total demand are modeled as lognormal, as shown in graph 92.

In the third block 95, the illustrative forecast value for the total is shown as 190 units. The lognormal probability density for the total demand at 190 takes the value 0.0012 for the zero demand cases. The corresponding “likelihood” value for the nonzero cases is 0.0048, suggesting that the forecasted total demand of 190 is four times as likely when the item demand is nonzero as when it is zero. This is shown graphically in plot 92 in which vertical line 98 depicts the forecasted total (190), curve 96 shows the distribution of total demand when item demand is non-zero, and curve 100 shows the distribution of total demand when item demand is zero.

Bayes Rule states that the posterior (conditional) probabilities are proportional to the product of the likelihoods and the prior (unconditional) probabilities. In the example, these products sum to 0.0030. Dividing the products by 0.0030 yields a legitimate posterior probability distribution for aggregated item demand (legitimate because it sums to unity).

In the rightmost block 97, the aggregated (two-level) posterior distribution is disaggregated to break out the probabilities of all observed item demand values. The disaggregation adjusts the probabilities of nonzero item demands so that they keep their original relative proportions while still summing to 0.793, the overall conditional probability of a nonzero item demand, given the forecast.

The end result of these calculations is that the forecast of 190 units for the total demand for all items has shifted the forecasted distribution of demand for the selected item upwards: a zero value is less likely to occur and each of the nonzero value more likely, all relative to the probabilities computed without reference to the forecast of total demand. The results are shown in graph 94.

An illustrative process is described with reference to FIG. 12. At S20, based on historical demand data, a demand probability distribution for the selected item is determined (i.e., prior probability distribution) and then aggregated to two levels, zero and nonzero.

Next, at S21, a forecast for total demand for all items for a next time period in the lead time is calculated in any known manner, e.g., Winters' exponential smoothing. At S22, determine a probability of zero and nonzero demand for the selected item at the forecasted total demand. In other words, as shown in FIG. 11, if the total demand is 190, determine the likelihood of a demand of 190 given that the demand for the selected item will be zero and nonzero. Then, at S23, use the zero and nonzero likelihoods to create a new (posterior) item demand probability distribution for the selected item.

One technique for performing these steps is to first fit a lognormal pdf to each set of data on total demand. This gives the likelihoods. Next, compute the two posterior probabilities by multiplying the likelihoods times the prior probabilities and normalizing to sum to unity. Treat all the nonzero values as a block, raising or lowering their total posterior probabilities together. (In cases in which there is abundant data, one could convert this two-level scheme into a three or more level scheme that follows the same principles, e.g., instead of dividing data by zero vs. nonzero item demand, one could use zero vs. low vs. high item demand.)

At S24, the posterior probabilities are generated for each time period in the lead time being forecast. At S25, the posterior probabilities are utilized to generate N LTD sequences. This may be done in any manner, e.g., Monte Carlo method, etc.

IV. Clustering using Linked Markov Model

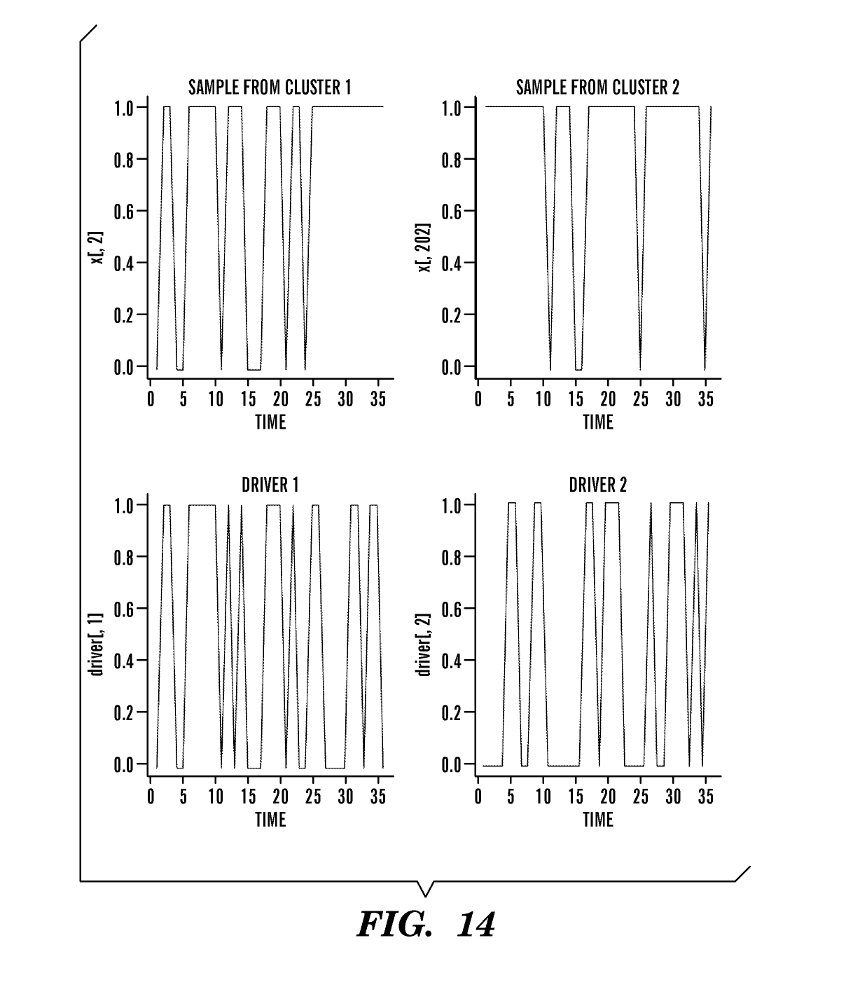

This process builds upon the Smart Bootstrap technique in which a Markov model is utilized to determine if a next demand value in an LTD sequence is zero or nonzero, knowing that a preceding demand value was zero or nonzero. The current approach treats the occurrence of zero demand for a given item as a Markov process whose transition probabilities are logistic functions of another stochastic process called a cluster driver series. The driver series are what functionally define clusters. FIG. 13 shows this idea schematically in which the probability of demand going between zero and nonzero depends upon a cluster driver.

An initial step of the process is to convert an item's intermittent demand history into zero and nonzero values, the latter temporarily represented by ones. The ones are later replaced with bootstrap samples from the actual nonzero values, plus a jittering factor to allow for values not yet seen in the item's demand history. A binary Markov model then represents the random sequence of item i's zero and nonzero demands, X_{i,t}. An innovation in this approach is that the state transition probabilities P₀₁ and P₁₀ for every item in a cluster are modeled as logistic functions of the state of another stochastic process representing the cluster driver (represented in FIG. 13 as another binary Markov process, though it might also be a continuous process; the model in FIG. 13 is also known as a Markov-modulated Markov process).

Drivers work by influencing the state transition probabilities of each item in the cluster. In the case of a binary driver, when the driver is “on” or “high”, transitions from 0 to 1 are more likely and from 1 to 0 are less likely. The equations governing the state transition probabilities to and from states 0 and 1 for item i at time t given driver value Dₜ are

P₀₁(i,t)=1/[1+exp(−αᵢ+γᵢDₜ)] (1)

P₁₀(i,t)=1/[1+exp(−βᵢ−γᵢDₜ)] (2)

There are three parameters in the linked Markov model. Parameter α controls the extent to which a zero value is followed by another zero. Parameter β plays the same role for nonzero values. In this way α and β govern the autocorrelation of the demand for an individual item. Parameter γ is the key to clustering: it controls the strength of the crosscorrelation among items in the same cluster by governing the strength of the influence of the item's driver on the item's state transition probabilities.

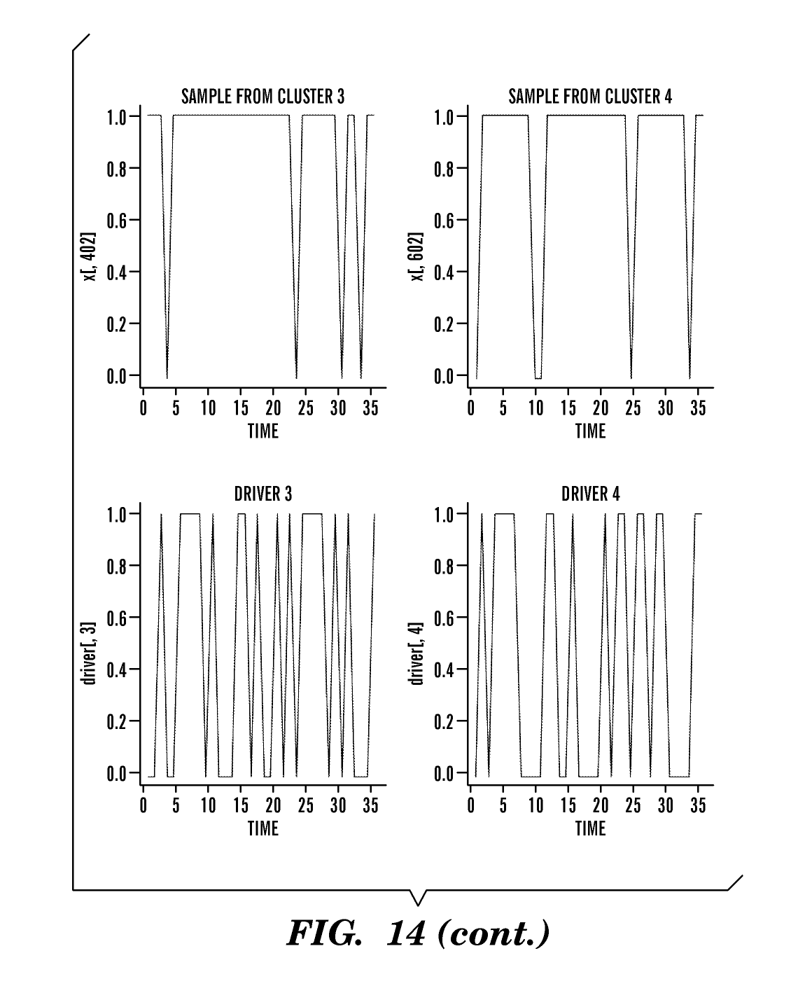

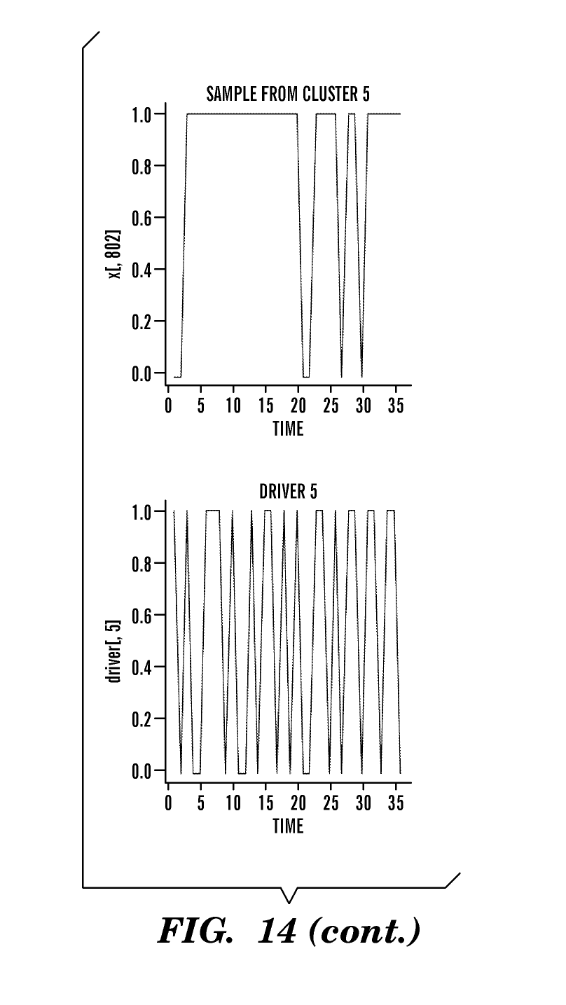

FIG. 14 shows samples of a synthetic dataset having five clusters. The top row shows individual item demand sequences, clipped to zero vs. nonzero levels. The bottom row shows the corresponding binary cluster drivers.

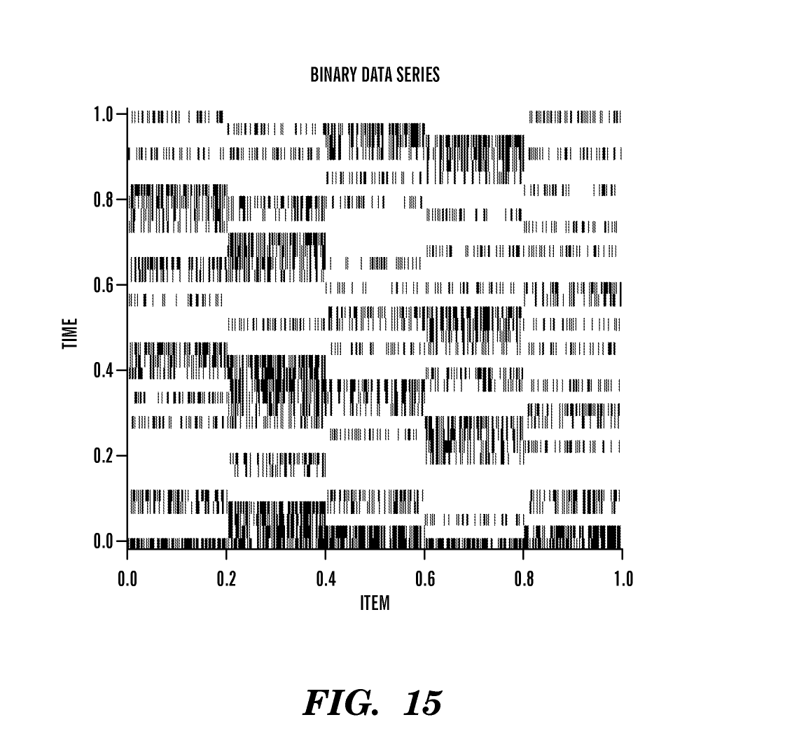

Clearly, the relationship between an individual item and its drivers can be quite subtle when looked at individually, as in FIG. 14. However, taking a cluster-wide view reveals strong structure. FIG. 15 shows a heat plot of the binary item series for all clusters. White indicates there is a nonzero demand and black means no demand. The horizontal synchrony within each cluster is readily apparent and creates the visual impression of sharp vertical delineations between adjacent clusters.

Using scenario analysis, it can be demonstrated that, even for short lead times, the variations in a cluster driver can create large differences in the lead time distributions of individual items. Furthermore, customers are also interested in the behavior of aggregates, such as the sum of lead time demands for all the items in a cluster. There are plausible scenarios in which the variability in cluster sums is seven times greater than that implied by the variability of individual items in the cluster. Such variance inflation is caused by the crosscorrelations induced by cluster drivers, which are ignored when forecasts are made item-by-item.

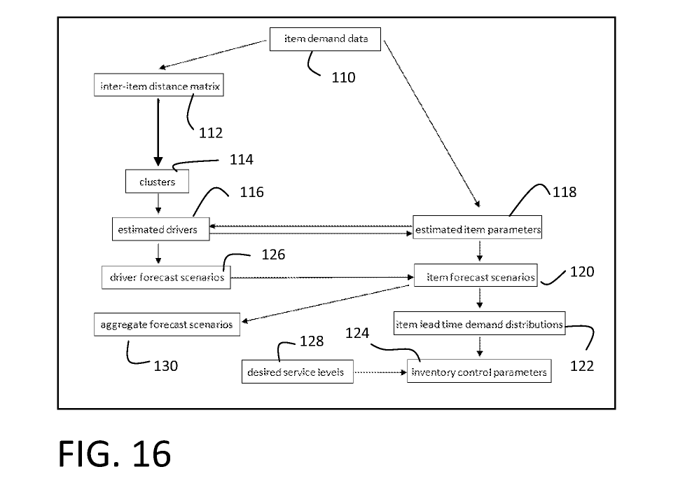

FIG. 16 is a schematic representation of cluster-based forecasting for spare and service parts. The item demand data 110 are clipped to binary form, X_{i,t}, then used to compute an inter-item distance matrix 112. Clipping not only simplifies the modeling of the data but it loses remarkably little information and allows for very efficient storage. From the inter-item distance matrix 112 one or more clusters 114 are identified.

The item demand data 110 and the cluster 114 identities are used in an iterative loop to estimate the parameters 118 (α, β and γ) of the linked Markov model. In one illustrative embodiment, a k-means algorithm is used to group items into clusters based on the distance matrix 112. However, it is understood that any other technique for clustering items could be utilized.

This results in an initial approximation to the latent cluster drivers using the sums of the clipped item demands in each cluster. Initial estimates of the item parameters α and β are formed using, e.g., the method of moments, assuming γ=0. Then final estimates of the item parameters 118 and drivers 116 are computed, e.g., by maximum likelihood using Nelder-Mead numerical search in three dimensions. It is understood that alternative numerical solution methods may be used.

Given estimates of the driver histories, future values of the drivers 126 will be forecasted and then converted, via the linked Markov model equations (1) and (2), into forecasts of all the items 120 in each driver's cluster. The item forecasts 120 will also depend on the estimates 118 of the individual items' values of parameters α, β, and γ. The driver forecasts 126 will be expressed as stochastic scenarios, as will the item forecasts 120 and any aggregates 130 derived from them, such as cluster totals or the dollar equivalents of cluster totals. Each item forecast 120 will include an LTD sequence in binary form, e.g., a nine month forecast scenario (i.e., prediction) may be forecasted as: 001011000.

In the next stage, the binary item forecasts in the LTD sequence are converted back to demand units by bootstrapping the nonzero demand values and then jittering the historical nonzero demand values by adding appropriately scaled random offsets to the resampled values. For instance, the above binary LTD sequence example may be converted to: 003014000, having a summed LTD of eight for the nine month period. A large number of these are run to create LTD distributions 122 for each item.

Item LTD distributions 122 may then be utilized to compute inventory control parameters along with desired service 128 levels to manage inventory levels in a control system.

### V. Computerized Implementation

It is recognized that computer system 10 of FIG. 1 could comprise additional and related components, and that each of the computer system components could reside in a single computer system, a distributed network, or a cloud computing environment, including a local area network (LAN) or the World Wide Web. Furthermore, the invention could be implemented with multiple processors in a parallel processing system, or by special purpose hardware.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” or “R” or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including Instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer system having a processor and memory for forecasting intermittent demand, comprising:
a data management system, wherein the data management system provides access to historical demand data for a plurality of items; and
a forecast system, wherein the forecast system generates a distribution of lead time demand predictions for a selected item having intermittent demand, and wherein the forecast system includes program code for performing the steps of:
identifying a cluster from historical demand data, wherein the cluster includes a set of items having an aggregated demand that defines a cluster driver;
detecting if an association exists between historical demand data of a selected item and the cluster driver; and
if the association is detected, utilizing the historical demand data of the selected item and the historical demand data of the cluster to generate a distribution of lead time demand predictions for the selected item.

2. The computer system of claim 1, wherein the cluster includes all of the plurality of items contained in the historical demand data.

3. The computer system of claim 1, wherein the association includes one of a positive association and a negative association.

4. The computer system of claim 1, wherein the distribution of lead time demand predictions for the selected item are generated utilizing a kernel weighting process.

5. The computer system of claim 1, wherein the distribution of lead time demand predictions for the selected item are generated utilizing a Binary Bayes process.

6. The computer system of claim 1, wherein the program code further performs the step of: if no association is detected, utilizing demand data only of the selected item to generate the distribution of lead time demand values for the selected item.

7. The computer system of claim 1, further comprising an inventory management system that statistically analyzes the distribution of lead time demand predictions to forecast demand for items in an inventory.

8. A method for forecasting intermittent demand, comprising:
identifying a cluster from historical demand data, wherein the cluster includes a set of items having an aggregated demand that defines a cluster driver;
using a computing device to detect if an association exists between historical demand data of a selected item and the cluster driver; and
if the association is detected, utilizing the historical demand data of the selected item and the historical demand data of the cluster to generate a distribution of lead time demand predictions for the selected item.

9. The method of claim 8, wherein the cluster includes all of a plurality of items contained in the historical demand data.

10. The method of claim 8, wherein the association includes one of a positive association and a negative association.

11. The method of claim 8, wherein the distribution of lead time demand predictions for the selected item is generated utilizing a kernel weighting process.

12. The method of claim 8, wherein the distribution of lead time demand predictions for the selected item is generated utilizing a Binary Bayes process.

13. The method of claim 8, wherein, if no association is detected, utilizing demand data only of the selected item to generate the distribution of lead time demand predictions for the selected item.

14. The method of claim 8, further comprising: statistically analyzing the distribution of lead time demand predictions using an automated process to forecast demand for items in an inventory.

15. A computer readable storage medium having a program product stored thereon for forecasting intermittent demand, comprising:
program code that identifies a cluster from historical demand data, wherein the cluster includes a set of items having an aggregated demand that defines a cluster driver;
program code that detects if an association exists between historical demand data of a selected item and the cluster driver; and
program code that utilizes historical demand data of the selected item and historical demand data of the cluster to generate a distribution of lead time demand predictions for the selected item if the association is detected.

16. The computer readable storage medium of claim 15, wherein the cluster includes all of a plurality of items contained in the historical demand data.

17. The computer readable storage medium of claim 15, wherein the association includes one of a positive association and a negative association.

18. The computer readable storage medium of claim 15, wherein the distribution of lead time demand predictions for the selected item is generated utilizing a kernel weighting process.

19. The computer readable storage medium of claim 15, wherein the distribution of lead time demand predictions for the selected item is generated utilizing a Binary Bayes process.

20. The computer readable storage medium of claim 15, further comprising program code that utilizes historical demand data only of the selected item to generate the distribution of lead time demand predictions for the selected item if no association is detected.

21. The computer readable storage medium of claim 15, further comprising: program code that statistically analyzes the distribution of lead time demand predictions to forecast demand for items in an inventory.

22. A cluster-based forecasting system for forecasting lead time demand for an item based on inputted intermittent data, wherein the forecasting system includes a processor and memory, and further comprises:
a system that identifies a cluster from historical demand data, wherein a behavior of the cluster is characterized by a cluster driver;
a forecast system that utilizes the cluster driver to forecast a demand value for a selected item in the cluster;
a system that generates a lead time demand prediction for the selected item from a sequence of forecasted demand values; and
a system that generates a distribution of lead time demand predictions for the selected item.

23. The cluster-based forecasting system of claim 22, wherein the forecast system utilizes a linked Markov modeling process.

24. The cluster-based forecasting system of claim 23, wherein the linked Markov modeling process is implemented using a pair of equations:
P₀₁(i,t)=1/[1+exp(−αᵢ+γᵢDₜ)] (1)
P₁₀(i,t)=1/[1+exp(−βᵢ−γᵢDₜ)] (2)
wherein P₀₁(i,t) and P₁₀(i,t) govern state transition probabilities to and from states 0 and 1 for item i at time t given a cluster driver Dₜ, and wherein parameters α and β govern an autocorrelation of demand for the selected item and parameter γ controls a strength of a crosscorrelation among items in the cluster.

25. The cluster-based forecasting system of claim 24, further comprising an iterative system for estimating the cluster driver and parameters α, β, and γ.

26. The cluster-based forecasting system of claim 22, wherein the forecast system utilizes a Binary Bayes process.

27. The cluster-based forecasting system of claim 22, wherein the forecast system utilizes a kernel weighting process.
